(19) United States
(12) Patent Application Publication
(10) Pub. No.: US 2011/0089736 A1
(43) Pub. Date: Apr. 21, 2011

(54) Seat Recliner Mechanism With Fold-Flat Feature

(75) Inventors: Kurt A. Seibold, Whitmore Lake, MI (US); Michael John Thomas, Ann Arbor, MI (US); Yogesh A. Pawar, Farmington Hills, MI (US)

(73) Assignee: JOHNSON CONTROLS TECHNOLOGY COMPANY, Holland, MI (US)

(21) Appl. No.: 12/675,067

(22) PCT Filed: Nov. 6, 2008
(86) PCT No.: PCT/US08/82541

§ 371 Date: Dec. 8, 2010

Related U.S. Application Data
(60) Provisional application No. 60/987,277, filed on Nov. 12, 2007.

(51) Int. Cl. B60N 2/235; B60N 2/20; B60N 2/02

(52) U.S. Cl. 297/367 R

(57) ABSTRACT

A vehicular seat assembly (14) having a backrest (16) capable of reclining between maximum upright (22) and maximum rearward (20) conditions. The backrest (16) can also be rotated to a fold-flat condition (24). A rotary recliner mechanism (26) controls reclining motion of the backrest (16). A dump latch (44) is operatively associated with the rotary recliner mechanism (26), and is automatically actuated by movement of the seat backrest (16) past its maximum upright condition (22). The dump latch (44) is controlled by a trigger (50) which interacts with a cam (60) on a base plate (28) of the rotary recliner mechanism (26). A biasing member (54) automatically resets the trigger (50) when the backrest (16) is returned to its maximum upright position (22). The dump latch (44) and biasing member (54) are carried on a toothed top plate (32) that is formed integrally with the rotary recliner mechanism (26).

### CROSS REFERENCE TO RELATED APPLICATIONS

This application claims priority to U.S. Provisional Application No. 60/987,277 filed on Nov. 12, 2007 entitled “Fold Flat Set Hinge Mechanism,” and PCT International Application No. PCT/US2008/082541 filed on Nov. 6, 2008 entitled “Seat Recliner Mechanism With Fold-Flat Feature,” the applications being incorporated herein by reference.

### BACKGROUND OF THE INVENTION

1. Field of the Invention

The subject invention relates generally to a vehicular seat assembly of the type for reclining a backrest rearwardly and also forwardly to a substantially flat condition.

2. Related Art

Vehicular seat assemblies typically include a seat cushion and a backrest that is hingedly connected to the seat cushion. A recliner mechanism is located at the connection between seat cushion and backrest to control reclining movement of the backrest and lock in any one of various angular positions. It is also desirable to provide fold-flat functionality whereby the backrest, when rotated forwardly, is able to achieve a substantially flat condition overlying the seat cushion. Recline (rearward) and fold-flat (forward) functionality enables better use of the passenger compartment space. Folding the backrest to a forward flat position allows large items to be more easily stowed, improved visibility within the passenger compartment, and overall more flexible and efficient use of space over a variety of configurations.

A generally puck-shaped, internally-toothed, rotary style recliner mechanism may be employed to provide the recline functionality. These rotary recliner mechanisms, commonly referred to by seating engineers as the “heart,” use an internal cam style mechanism with biased moveable locking members having selectively engagable teeth enclosed between encapsulating end plates. Examples of such rotary reclining mechanisms without fold flat functionality may be found in U.S. Pat. Nos. 7,144,082, 7,150,503, and US Publication No. 2006/0279121, the disclosures of which are hereby incorporated by reference for describing the features and general operation of a puck-shaped rotary recliner mechanism. The recliner mechanism is interposed between a base plate and a top plate—two structural members affixed, respectively, to the frames of the seat cushion and backrest. The encapsulating end plates of the recliner mechanism are either welded or otherwise securely fastened to the respective base plate and top plate.

A typical rotary recliner mechanism, whether or not capable of fold flat functionality, is spring biased to a locked condition, i.e., so the seat backrest is fixed in an angular position until the recliner mechanism is intentionally activated. An actuator, typically a handle or lever, must be manipulated to actuate the cam mechanism and disengage the teeth. Once the teeth inside the lock member have been withdrawn to an unlocked position, the backrest is free to articulate. Such rotary recliner mechanisms are carefully designed to meet current safety requirements while also limiting the amount of slack or play that can be perceived by a seat occupant. Secure welds or other fastening techniques are used to secure the base plate to one side of the puck-shaped recliner mechanism and the top plate to the other side. As a result, prior art recliner mechanisms tend to be heavily constructed items, adding significantly to vehicle weight.

Typically, rotary recliner mechanisms that enable forward fold-flat articulation of the backrest are cumbersome to operate. Examples include U.S. Pat. Nos. 6,739,668, 6,464,299 and 6,805,408. In many instances, the occupant must coordinate movement of the seat back and an actuator handle of the rotary recliner mechanism in a particular sequence so that the backrest can be released to fold forwardly. In other instances, a second lever actuator is manipulated to release the back rest to fold forwardly. These mechanisms are difficult to operate, particularly by those unfamiliar with the vehicle or with low mechanical aptitudes. Some seats have a fold flat mechanism that enabled fold-flat functionality through the use of a so-called “dump latch” carried on the top plate. This construction made the fold-flat operation easier by automatically unlocking the backrest once it reached a full upright condition. While effective, it is the desire of manufacturers to provide lighter weight seats and reduce manufacturing. Accordingly, there is a need for an improved seat recliner mechanism that enables a fold-flat feature that is robust, inexpensive to manufacture, easy to operate, and lighter in overall weight.

### SUMMARY OF THE INVENTION

A vehicular seat assembly includes a seat cushion and a backrest. A rotary recliner mechanism is configured to establish incremental reclining adjustments about a generally horizontal first axis to permit relative pivotal movement between the backrest and the seat cushion. The rotary recliner mechanism includes at least one integrated base plate and/or top plate fixed relative to the seat cushion and/or backrest for movement about the first axis. A dump latch is fixed relative to the backrest and hingedly carried on the top plate about a second axis that is parallel to, and spaced from, the first axis. In this manner, the subject invention provides a simple yet robust and easily operated vehicular seat recliner mechanism in which at least one of the top plate and/or base plate are integrated with the rotary recliner mechanism.

Moreover, the subject invention enables fold-flat functionality through the use of a dump latch which is independently hinged relative to the rotary recliner mechanism. Rotation of the backrest with its integral toothed top plate causes a trigger to engage a cam which automatically unlocks the dump latch so that the backrest is able to fold forwardly to a substantially flat condition about the second axis. The top plate and/or base plate is formed as an integral member of the rotary recliner mechanism. The integrated top plate rotates about the first axis when the recliner mechanism is actuated, and the integrated base plate interacts with the trigger for the dump latch.

### BRIEF DESCRIPTION OF THE DRAWINGS

These and other features and advantages of the present invention will become more readily appreciated when considered in connection with the following detailed description and appended drawings, wherein:

FIG. 1 is a simplified perspective view of a motor vehicle including at least one seat assembly according to the subject invention;

FIG. 2 is a side elevation view of a seat assembly according to the subject invention, wherein the backrest is shown in various reclined and forward folded conditions in phantom;

FIG. 3 is a perspective view of a seat assembly according to the subject invention wherein the backrest is depicted in a substantially flat, forward folded condition;

FIG. 4 is an end view of a rotary recliner mechanism, dump latch and trigger according to the subject invention;

FIG. 5 is a right side view as taken generally along lines 5-5 in FIG. 4;

FIG. 6 is a left side view as taken generally along lines 6-6 in FIG. 4;

FIG. 7 is an exploded view of the rotary recliner mechanism, dump latch and trigger of this invention;

FIGS. 8A and 8B are simplified views of the subject rotary recliner mechanism, dump latch and trigger according to this invention showing the backrest moved from an initial to a rearwardly reclined condition;

FIGS. 9A and 9B are views as in FIGS. 8A and 8B, but here depicting the backrest assembly rotated forwardly until the point at which the trigger automatically interacts with a cam extending from the base plate; and

FIGS. 10A and 10B represent a further progression of backrest movement rotating forwardly to a substantially flat condition.

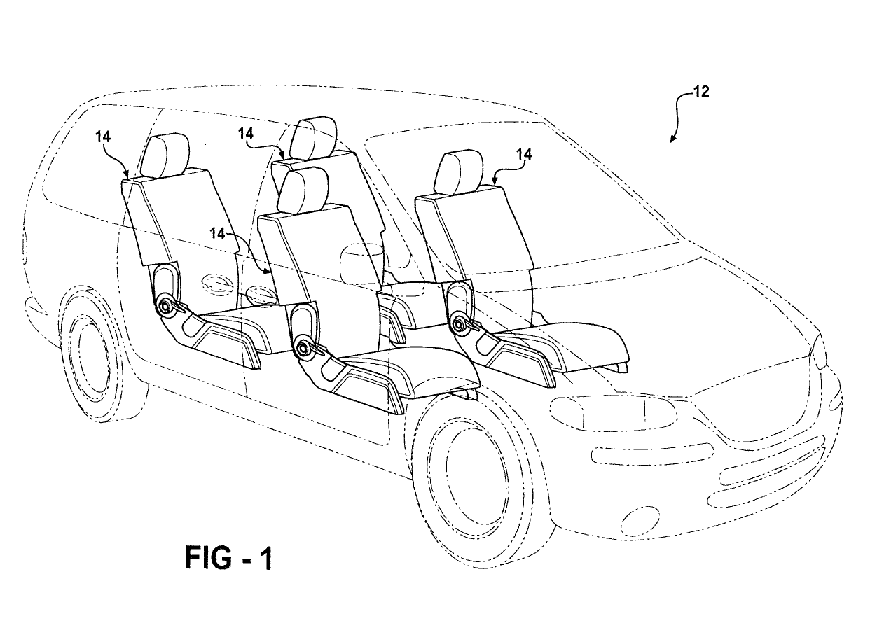

### DETAILED DESCRIPTION OF THE PREFERRED EMBODIMENT

Referring to the Figures, wherein like numerals indicate like or corresponding parts throughout the several views, an exemplary motor vehicle is shown generally at 12. The vehicle 12 is shown here in the form of a passenger van, but it will be appreciated that the vehicle type is not relevant to this invention. The vehicle 12 includes at least one seat assembly, generally indicated at 14, of the type including a backrest 16 hingedly connected to a seat cushion 18. The seat cushion 18 is anchored to the floor of the passenger compartment using any of the various anchoring techniques, such as fore and aft adjustable slides, releasable hooks, fixed mounts, and the like.

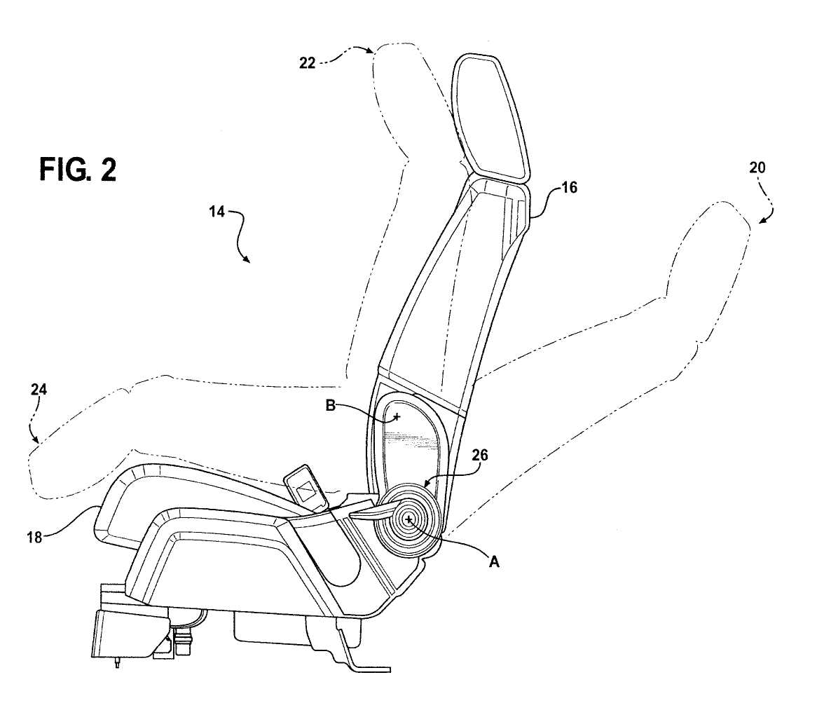

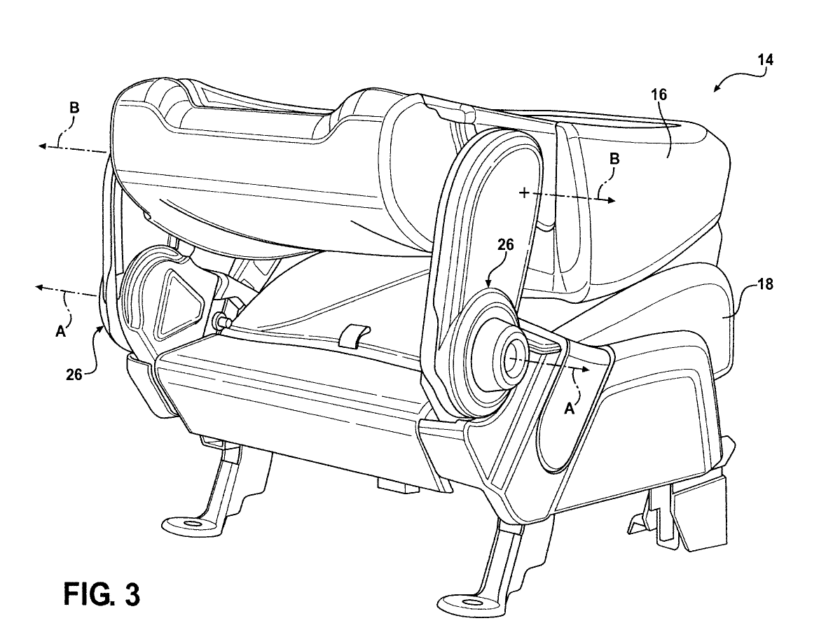

As shown in FIG. 2, the backrest 16 is capable of reclining rearwardly to a maximum rearward condition shown in phantom at 20. The angular orientation of the maximum rearward condition 20 is merely exemplary, and in fact either a greater or lesser degree of angular tilt may be achieved according to the design specification. The backrest 16 can be rotated to a maximum upright condition 22. Furthermore, the backrest 16 can be manipulated so as to rotate forwardly to a substantially flat condition 24, often referred to as fold-flat. The fold-flat condition 24 is shown from the rearward quartering perspective in FIG. 3.

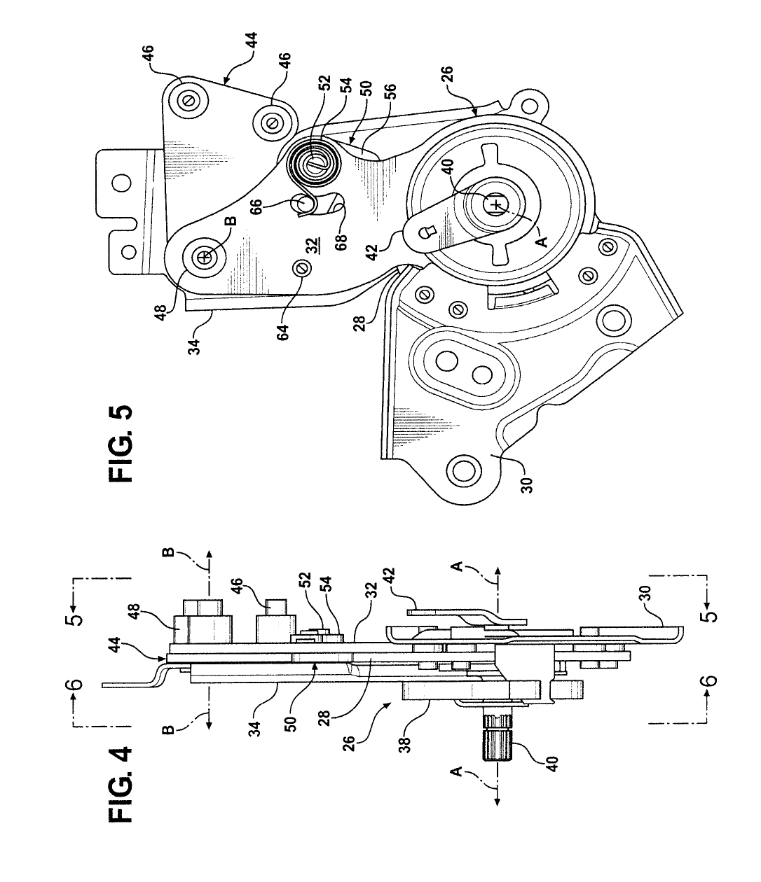

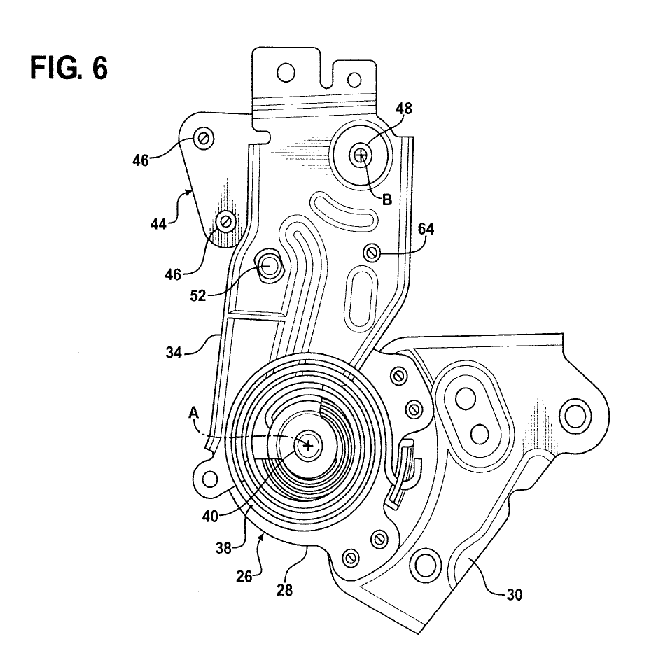

Movement of the backrest 16 between its maximum upright 22 and maximum rearward 20 reclining conditions is accomplished through a pair of rotary recliner mechanisms 26 as best illustrated in FIGS. 4-7. One rotary recliner mechanism 26 is located on each side of the seat assembly 14, and is of generally identical or mirror-image construction. The rotary recliner mechanism 26 is configured to establish incremental reclining adjustments about a generally horizontal first axis A. Thus, the rotary recliner mechanism 26 permits relative pivotal movement between the backrest 16 and the seat cushion 18. The rotary recliner mechanism 26 can accomplish incremental reclining adjustments using various tooth engaging or frictional/wedging constructions including, for example, those designs depicted in U.S. Pat. Nos. 7,150,503 and 7,144,082 and also in Patent Application Number US 2006/0279121, the disclosures of which are hereby incorporated by reference. These prior art examples describe various heart mechanisms, any one of which can be used with effectiveness in the rotary recliner mechanism 26 to accomplish incremental reclining adjustments of the type described here. The rotary recliner mechanism 26 includes opposing first and second portions supported relative to one another for rotation about the first axis A. The first portion includes a row of internal teeth 36 arranged circumferentially about the first axis A, and the second portion includes at least one tooth engaging member selectively moveable into and out of engagement with the row of internal teeth 36 so as to arrest relative rotation between the first and second portions when engaged with the row of internal teeth 36. Conversely, when the tooth engaging member is disengaged from the row of internal teeth 36, relative rotation between the first and second portions is permitted. Duly enabling construction details of these components may be had in the above-noted prior art references incorporated by reference herein.

The rotary recliner mechanism 26 includes an integrated base plate 28 fixed relative to the seat cushion 18. The base plate 28 is fixedly joined to one of the first and second portions of the recliner mechanism 28, but in the preferred embodiment is co-formed with the second portion. The base plate 28 can be either directly connected to a frame of the seat cushion 18, or as shown in FIGS. 4-7 joined to a lower bracket 30 which in turn is affixed to a frame of the seat cushion 18. Thus, the lower bracket and base plate 28 are effectively integral members. In prior art constructions, the feature equivalent to the base plate was welded or otherwise fastened to one of the end plates of the rotary recliner mechanism, such as shown in for example in US Publication No. 2006/0279121. However, in this design, the end plate and prior art style base plate have been merged and integrated into a unitary member 28, thereby reducing weight, cost and complexity.

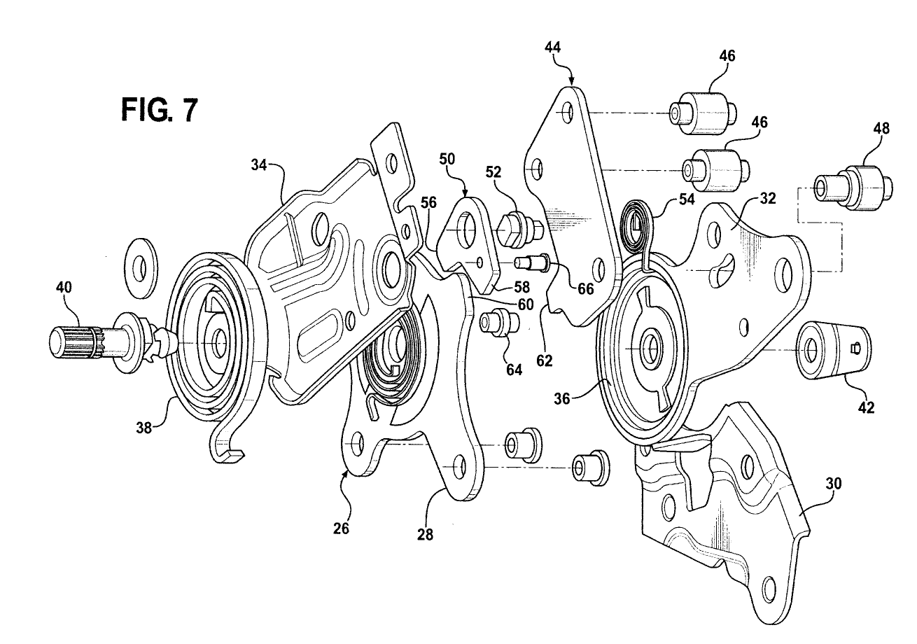

The rotary recliner mechanism 26 further includes a top plate 32 that is pivotally supported relative to the base plate 28 for movement about the first axis A. The top plate 32 is fixedly joined to the other of the first and second portions of the recliner mechanism 26 for relative arcuate displacement about the first axis A. Preferably, however, the top plate 32 is co-formed with the first portion, thereby integrating therein the internal teeth 36 of the rotary recliner mechanism 26. The top plate 32 may be affixed to an upper bracket 34 so as to sandwich the base plate 28 therebetween. The heart mechanism, which provide incremental reclining adjustments through engagement of interactive teeth or wedging members, is contained between the base plate 28 and toothed top plate 32. Typically, the top plate 32 will include the internal teeth 36 for this purpose, such as shown in FIG. 7. Thus, the toothed top plate 32 is integrated directly with the rotary recliner mechanism 26, in this embodiment forming half of the cooperating mechanism. In prior art constructions, the feature equivalent to the top plate was welded or otherwise fastened to one of the end plates of the rotary recliner mechanism, such as shown in for example in US Publication No. 2006/0279121.

A recliner spring 38 acts between the upper 34 and lower 30 brackets to urge the backrest 16 toward its maximum upright condition 22. An actuator shaft 40 passes through the recliner spring 38 and aligned holes in the upper bracket 34 and base plate 28 to actuate the heart mechanism. Splines may be provided on the end of the actuator shaft 40 to receive a lever or other type of cranking mechanism so that twisting of the actuator shaft 40 will cause the heart mechanism to disengage its interlocking teeth and allow rotation of the toothed top plate 32, and hence the backrest 16, to any desired orientation between the maximum rearward 20 and maximum upright 22 conditions. The actuator shaft 40 preferably extends through an aligned hole in the toothed top plate 32 to receive a crank 42 on its extreme opposite end. The crank 42 attaches to a flexible motion transmitting cable (not shown) so that a rotary recliner mechanism 26 at the other side of the seat assembly 14 can be operated in tandem. As an alternative to the crank 42, the actuator shaft 40 can be elongated and extend clear to the other side of the seat assembly 14 for directly actuating both rotary recliner mechanisms 26 with a single manipulation of a lever or other actuating device.

A dump latch, generally indicated at 44, is fixed to the backrest 16 such as by fasteners 46 which engage a frame, shell or other structural feature of the backrest 16. The dump latch 44 is hingedly carried on the top plate 32 about a second axis B that extends parallel to, and is spaced from, the first axis A. Because the top plate 32 houses the internal teeth of the rotary recliner mechanism 26, the overall assembly can be made lighter and less expensive without sacrificing structural integrity. Furthermore, assembly of the components is easier due to the integrated top plate 32 and rotary recliner mechanism 26.

As perhaps best shown in FIGS. 2 and 3, both the first A and second B axes are generally horizontal. The second axis B sweeps an arc about the first axis A as the toothed top plate 32 is articulated between the maximum rearward 20 and maximum upright 22 reclining conditions. However, movement of the backrest 16 from the maximum upright condition 22 toward the fold-flat condition 24 does not displace the second axis B. Rather, during the fold-flat operation, the second axis B remains stationary, with only the backrest 16 pivoting thereabout via the hinged dump latch 44. A first pivot pin 48 adjoins the dump latch 44 to the toothed top plate 32 at the second axis B for captured pivotal movement.

A trigger, generally indicated at 50, has something of a boomerang shape and is pivotally connected to the toothed top plate 32 by a second pivot pin 52. A biasing member 54, shown here in the form of a flat wound coil spring, acts on the trigger 50. One leg of the trigger 50 serves as a follower 56 whereas the other leg comprises a lug 58.

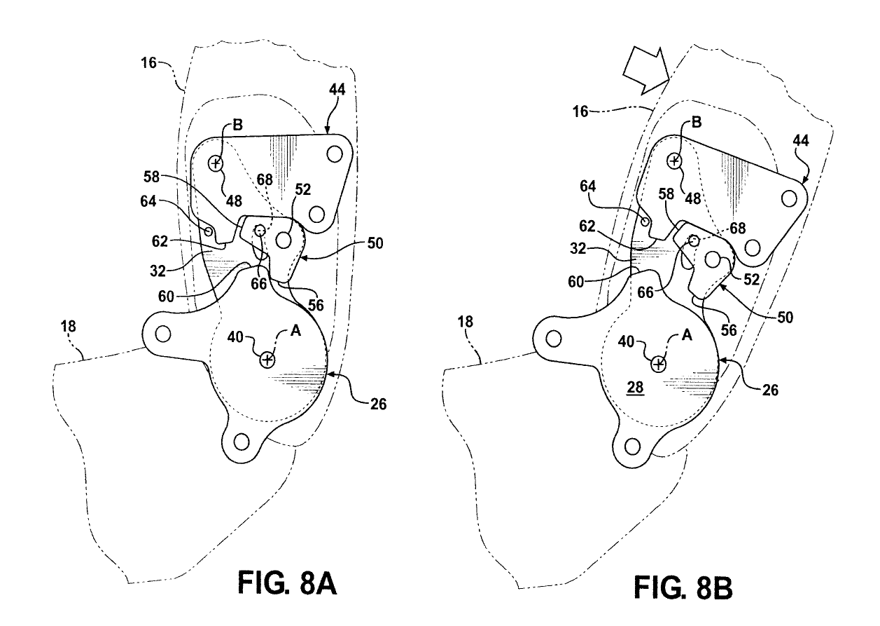

A cam 60 is formed as a lobe-like feature on the base plate 28. The cam 60 is oriented so as to automatically engage the follower 56 on the trigger 50 when the backrest 16 is moved beyond its maximum upright condition 22. During reclining movement of the backrest 16, i.e., between its maximum upright 22 and maximum rearward 20 conditions, the follower 56 does not contact the cam 60. This is perhaps best illustrated in FIGS. 8A and 8B.

During reclining movement of the backrest 16, the dump latch 44 is held in a locked condition relative to the toothed top plate 32 by the trigger 50. More specifically, the dump latch 44 includes a nose 62 that is trapped between the lug 58 of the trigger 50 and an abutment 64. Preferably, although not necessarily, the abutment 64, nose 62, lug 58 and second pivot pin 52 are generally aligned along a common vector whenever the backrest 16 moves between its maximum upright 22 and maximum rearward 20 conditions, as shown in FIGS. 8A and 8B. This provides a robust latching mechanism, because compression forces are transmitted directly between the second pivot pin 52 and abutment 64 without introducing torsional moments.

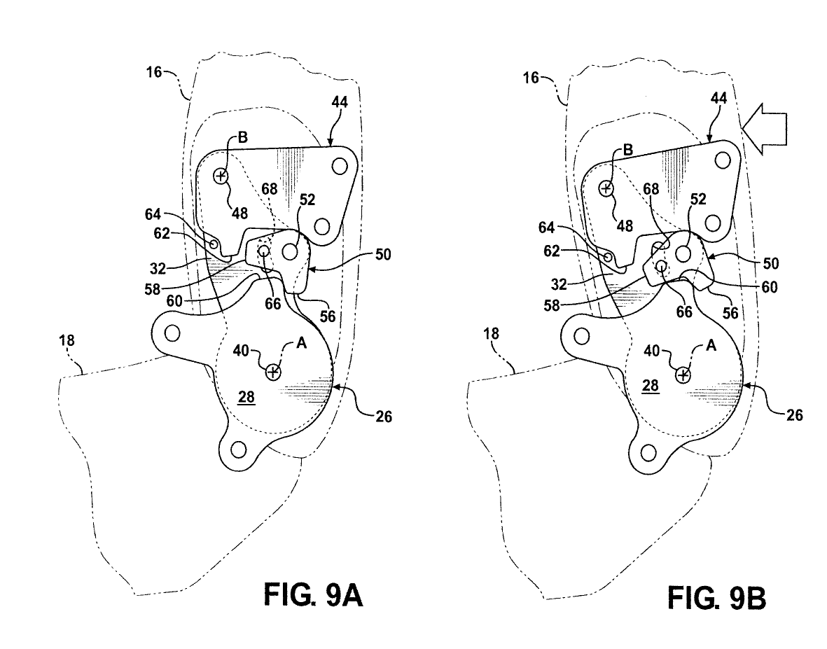

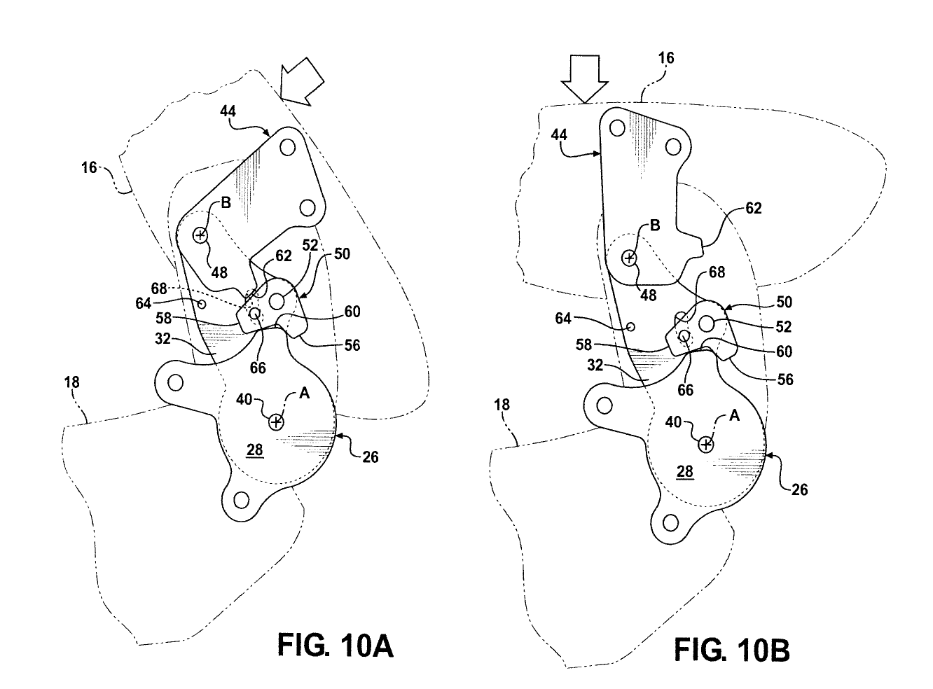

Forward movement of the backrest 16 beyond the maximum upright condition 22 causes the follower 56 of the trigger to interact with the cam 60, causing a rocking motion of the trigger 50 about its second pivot pin 52. This rocking motion has the effect of rotating the lug 58 out of position with respect to the nose 62, thereby allowing the dump latch 44 to rotate with its first pivot pin 48. This is illustrated in FIGS. 9A, 9B, 10A and 10B. When it is desired to return the backrest 16 to an upright or rearwardly reclined condition, the backrest 16 is simply rotated, together with its affixed dump latch 44, until the nose 62 of the dump latch 44 strikes the abutment 64. Whereupon, a torque is produced in the toothed top plate 32 thereby forcing it to rotate about the first axis A. Such movement carries with it the trigger 50, which rocks back toward the nose 62 via action of the biasing member 54. A travel limiting member may be incorporated into the trigger 50, which, in the case shown here, includes a pin 66 captured in a slot 68 on the toothed top plate 32. The travel limiting member prevents over-rotation of the trigger 50.

Accordingly, the subject invention provides an easily operated, simply constructed and robust assembly of components whereby the backrest 16 is automatically released to dump forward to the fold-flat condition 24 when the recliner mechanism 26 exceeds by a predefined distance beyond its maximum upright condition 22. That is, once the toothed top plate 32 exceeds its maximum upright condition 22 by a present amount, the trigger 50 is automatically displaced by the cam 60, such that continued forward movement toward the fold-flat condition 24 releases the dump latch 44 to pivot freely about the second axis B. The trigger 50 automatically resets once the backrest 16 is returned to its maximum upright condition 22, at which time the rotary recliner mechanism 26 is reengaged to permit controlled rearward reclining movement of the backrest 16 in the manner described above.

The foregoing invention has been described in accordance with the relevant legal standards, thus the description is exemplary rather than limiting in nature. Variations and modifications to the disclosed embodiment may become apparent to those skilled in the art and fall within the scope of the invention. Accordingly the scope of legal protection afforded this invention can only be determined by studying the following claims.

What is claimed is:

1. A dual axis recliner assembly for a vehicular seat of the type including a backrest hingedly connected to a seat cushion and capable of being rotated forwardly to a substantially flat condition, said assembly comprising:
an internally toothed rotary recliner mechanism configured to establish incremental reclining adjustments about a generally horizontal first axis to permit relative pivotal movement between a backrest and a seat cushion, said rotary recliner mechanism including opposing first and second portions supported relative to one another for rotation about said first axis, said first portion including a row of internal teeth arranged circumferentially about said first axis, and said second portion including at least one tooth engaging member selectively moveable into and out of engagement with said row of internal teeth so as to arrest relative rotation between said first and second portions when engaged with said row of internal teeth;
a base plate configured for fixed connection to the seat cushion and a top plate configured for fixed connection to the backrest, said base plate being fixedly joined to one of said first and second portions, and said top plate being fixedly joined to the other of said first and second portions of said recliner mechanism for relative arcuate displacement about said first axis;
a dump latch hingedly carried on said top plate about a second axis parallel to and spaced from said first axis, said dump latch configured for fixed connection to the backrest;
and wherein said top plate is co-formed as a single, unitary structure with the respective one of said first and second portions such that said top plate comprises an integral extension of its respective said first or second portion without any intermediate weld or fastener existing therebetween.

2. The assembly of claim 1 wherein said top plate is co-formed as a single, unitary structure with said first portion of said recliner mechanism such that said row of internal teeth are formed integrally within the structure of said top plate.

3. The assembly of claim 1 further including a trigger pivotally carried on said top plate, said trigger being selectively manipulated to lock and unlock said dump latch relative to said top plate in response to rotation of said top plate about said first axis.

4. The assembly of claim 3 further including a cam, and wherein said trigger includes a follower directly engageable with said cam.

5. The assembly of claim 4 wherein said cam is fixed relative to said base plate.

6. The assembly of claim 5 wherein said dump latch includes a nose and said trigger includes a lug moveable toward and away from said nose when said trigger is pivoted.

7. The assembly of claim 6 wherein said top plate includes an abutment directly engageable with said nose of said dump latch.

8. The assembly of claim 6 wherein said trigger includes a biasing member for urging said lug toward said nose of said dump latch.

9. The assembly of claim 8 wherein said trigger includes a travel limiting member.

10. The assembly of claim 9 wherein said travel limiting member includes a pin captured in a slot on said top plate.

11. The assembly of claim 10 wherein said biasing member directly engages said pin of said travel limiting member.

12. A dual axis recliner assembly for a vehicular seat of the type including a backrest hingedly connected to a seat cushion and capable of being rotated forwardly to a substantially flat condition, said assembly comprising:
an internally toothed rotary recliner mechanism configured to establish incremental reclining adjustments about a generally horizontal first axis to permit relative pivotal movement between a backrest and a seat cushion, said rotary recliner mechanism including opposing first and second portions supported relative to one another for rotation about said first axis, said first portion including a row of internal teeth arranged circumferentially about said first axis, and said second portion including at least one tooth engaging member selectively moveable into and out of engagement with said row of internal teeth so as to arrest relative rotation between said first and second portions when engaged with said row of internal teeth;
a base plate configured for fixed connection to the seat cushion and a top plate configured for fixed connection to the backrest, said base plate being fixedly joined to one of said first and second portions, and said top plate being fixedly joined to the other of said first and second portions of said recliner mechanism for relative arcuate displacement about said first axis;
a dump latch hingedly carried on said top plate about a second axis parallel to and spaced from said first axis, said dump latch being interactive with a cam for selectively locking and unlocking said dump latch relative to said top plate in response to rotation of said top plate about said first axis;
and wherein said cam is co-formed as a single, unitary structure with said base plate such that said cam comprises an integral extension of said base plate without any intermediate weld or fastener existing therebetween.

13. The assembly of claim 12 wherein said base plate is co-formed as a single, unitary structure with said second portion of said recliner mechanism.

14. The assembly of claim 12 further including a trigger pivotally carried on said top plate, said trigger being selectively manipulated to lock and unlock said dump latch relative to said top plate in response to rotation of said top plate about said first axis.

15. The assembly of claim 14 wherein said trigger includes a follower directly engageable with said cam.

16. The assembly of claim 15 wherein said dump latch includes a nose and said trigger includes a lug moveable toward and away from said nose when said trigger is pivoted.

17. The assembly of claim 16 wherein said top plate includes an abutment directly engageable with said nose of said dump latch.

18. The assembly of claim 16 wherein said trigger includes a biasing member for urging said lug toward said nose of said dump latch.

19. The assembly of claim 18 wherein said trigger includes a travel limiting member.

20. The assembly of claim 19 wherein said travel limiting member includes a pin captured in a slot on said top plate.

21. The assembly of claim 20 wherein said biasing member directly engages said pin of said travel limiting member.

22. A dual axis recliner assembly for a vehicular seat of the type including a backrest hingedly connected to a seat cushion and capable of being rotated forwardly to a substantially flat condition, said assembly comprising:
an internally toothed rotary recliner mechanism configured to establish incremental reclining adjustments about a generally horizontal first axis to permit relative pivotal movement between a backrest and a seat cushion, said rotary recliner mechanism including opposing first and second portions supported relative to one another for rotation about said first axis, said first portion including a row of internal teeth arranged circumferentially about said first axis, and said second portion including at least one tooth engaging member selectively moveable into and out of engagement with said row of internal teeth so as to arrest relative rotation between said first and second portions when engaged with said row of internal teeth;
a base plate configured for fixed connection to the seat cushion and a top plate configured for fixed connection to the backrest, said base plate being fixedly joined to one of said first and second portions, and said top plate being fixedly joined to the other of said first and second portions of said recliner mechanism for relative arcuate displacement about said first axis;
a dump latch hingedly carried on said top plate about a second axis parallel to and spaced from said first axis, said dump latch configured for fixed connection to the backrest;
said top plate being co-formed as a single, unitary structure with the respective one of said first and second portions such that said top plate comprises an integral extension of its respective said first or second portion without any intermediate weld or fastener existing therebetween, and said cam being co-formed as a single, unitary structure with said base plate such that said cam comprises an integral extension of said base plate without any intermediate weld or fastener existing therebetween.

23. The assembly of claim 22 wherein said top plate is co-formed as a single, unitary structure with said first portion of said recliner mechanism such that said row of internal teeth are formed integrally within the structure of said top plate, and wherein said base plate is co-formed as a single, unitary structure with said second portion of said recliner mechanism.

24. A vehicular seat assembly of the type including a backrest hingedly connected to a seat cushion and capable of reclining rearwardly and also being rotated forwardly to a substantially flat condition, said assembly comprising:
a seat frame;
a backrest frame;
an internally toothed rotary recliner mechanism configured to establish incremental reclining adjustments about a generally horizontal first axis to permit relative pivotal movement between a backrest and a seat cushion, said rotary recliner mechanism including opposing first and second portions supported relative to one another for rotation about said first axis, said first portion including a row of internal teeth arranged circumferentially about said first axis, and said second portion including at least one tooth engaging member selectively moveable into and out of engagement with said row of internal teeth so as to arrest relative rotation between said first and second portions when engaged with said row of internal teeth;
a base plate configured for fixed connection to the seat cushion and a top plate configured for fixed connection to the backrest, said base plate being fixedly joined to said second portion, and said top plate being fixedly joined to said first portion of said recliner mechanism for relative arcuate displacement about said first axis;
a dump latch hingedly carried on said top plate about a second axis parallel to and spaced from said first axis, said dump latch configured for fixed connection to the backrest;
and said top plate being co-formed as a single, unitary structure with said first portion of said recliner mechanism such that said row of internal teeth are formed integrally within the structure of said top plate, and wherein said base plate is co-formed as a single, unitary structure with said second portion of said recliner mechanism.
